(19) United States
(12) Patent Application Publication
(10) Pub. No.: US 2022/0331994 A1
(43) Pub. Date: Oct. 20, 2022

(54) METHOD FOR MAINTAINING SYSTEMS, IN PARTICULAR MACHINES IN WAREHOUSES

(71) Applicant: Dematic GmbH, Heusenstamm (DE)

(72) Inventors: Daniel Jarr, Offenbach (DE); Joshua Hartz, Gelnhausen (DE)

(21) Appl. No.: 17/720,799

(22) Filed: Apr. 14, 2022

(30) Foreign Application Priority Data
Apr. 15, 2021 (DE) 102021109512.3

(51) Int. Cl. B25J 19/06; B25J 19/02; B25J 13/00; B25J 9/16

(52) U.S. Cl. CPC B25J 19/061; B25J 19/023; B25J 13/003; B25J 13/006; B25J 9/1674

(57) ABSTRACT

A method for maintaining, commissioning and checking systems in warehouses, where a service technician has a view of the respective system and makes wireless contact with the controller of the system via a mobile computer in order to take over control thereof, where the taking over of control by the mobile computer is permitted by a central controller only if the service technician can have visual contact with the corresponding system, for which purpose the determination of the position and/or the orientation of the mobile computer of the service technician with respect to the respective system is effected via optical and/or acoustic recognition of a fingerprint of the system.

### CROSS REFERENCE TO RELATED APPLICATION

The present application claims the priority benefits of German patent application no. 10 2021 109 512.3, filed Apr. 15, 2021.

### BACKGROUND AND FIELD OF THE INVENTION

The invention relates to a method for maintaining systems, in particular machines in warehouses.

Warehouses and their installations must be regularly inspected, maintained and monitored, subject to legal specifications amongst other things.

For this purpose, tablets or computers connected by a wired connection are usually used for the commissioning, testing and for the maintenance and repair of the machinery in a warehouse, wherein e.g. a service technician must plug the tablet into a socket in the proximity of the machine, select the machine using its ID and can then begin work in order to override or to control a machine manually.

Some service providers already use radio-based or WiFi-based connections for the service tablet. They otherwise function in a similar way to the wired solutions.

The legal requirements (e.g. DGUV requirements) prescribe that the machinery to be controlled must be physically visible to the service technician. In other words, it must be ensured that the technician has the machine in view or that it is visible even during remote access via a laptop, tablet, smartphone, etc.

Thus, these solutions do not always meet the regulations since it cannot be ensured technically that the service technician actually has the machine in sight when using a radio connection.

US 2009/0084657 A1 describes a modular conveying system which comprises a plurality of conveying modules and a plurality of wireless machine communication points which are disposed on the plurality of conveying modules and are designed to communicate wirelessly via a mesh network.

U.S. Pat. No. 10,521,626 B2 discloses a material handling system with one or a plurality of sub-systems and one or a plurality of sensor panels. Each sensor panel can determine whether a mode control token is located in the proximity of the respective sensor panel. When a mode control token is in the immediate proximity of the respective sensor panel, the sensor panel can generate a signal, and, when the mode control token is outside the proximity of the respective sensor panel, the generation of the signal is stopped. The material transport system can also contain a processor which makes it possible for at least one sub-system of the material transport system to be activated in response to the generated signals or to be stopped owing to the absence of the signals.

EP 1 449 041 B1 describes the possibility of allowing control of a machine only if the access is provided via a specified access point of the network. Then, it is assumed that the service technician is situated in the environment. This approach is relatively imprecise.

### SUMMARY OF THE INVENTION

The present invention provides a method for maintaining machines in warehouses, in which the visibility of the machine for the service technician is ensured or is at least very highly probable.

In accordance with aspects of the invention, it has been recognised that if taking over of control by the mobile computer is only permitted by a central controller if the service technician can have visual contact with the corresponding system, for which purpose the determination of the position and/or the orientation of the mobile computer of the service technician to the respective system is effected via optical and/or acoustic recognition of a fingerprint of the system, the visibility of the system can actually be ensured in a simple manner wirelessly by a proximity of the service technician or his working device in the form of the mobile computer. In addition, the taking over of control of the system is facilitated and accelerated because it can be automated.

In a preferred embodiment, the acoustic recognition is effected by means of a microphone of the mobile computer which enables the central controller to compare an acoustic fingerprint stored in the central controller with instantaneous acoustic recordings of the noises of the respective system. In other words, a noise of the system is recorded by means of the built-in microphone(s) of the mobile computer and this is compared with a stored acoustic fingerprint in the central controller. From this, on the one hand, the system itself can be identified and, on the other hand, the distance of the mobile computer and, if at least two microphones are used, also an orientation to the respective system can be determined.

If the acoustic recognition by means of at least one microphone monitors both the frequency and the amplitude of the instantaneous noises of the system, it can also be ensured that the permissible distance from the system is maintained or is not exceeded.

The noises can be normal operating noises of the system. It is also possible to use artificially generated noises, e.g. in the range of 20 Hz to 20 kHz. Also, the use of ultrasound (above 20 kHz) or infrasound (below 20 Hz), preferably likewise artificially generated.

In a likewise preferred embodiment, the optical recognition is effected by means of a camera of the mobile computer which enables the central controller to compare an optical fingerprint stored in the central controller with instantaneous optical recordings of patterns of the respective system. In other words, an image of the system is recorded by means of the built-in cameras of the mobile computer and this is compared with a stored optical fingerprint in the central controller. From this, on the one hand, the system itself can be identified and, on the other hand, the distance of the mobile computer and, if at least two cameras or suitable image evaluation are used, also an orientation thereof to the respective system can be determined.

Preferably, the optical patterns consist of the system itself, markings applied on or in the immediate vicinity of the system (e.g. barcode, QR code, dot pattern, number sequence, serial number, etc.), markings applied on the floor in front of the system (e.g. barcode, QR code, dot pattern, number sequence, serial number, etc.) or light patterns on the system or combinations of the aforementioned.

In an expedient manner, the service technician can be identified by means of optical and/or acoustic recognition. For instance, image recognition or voice pattern recognition can be effected in order to authorise the service technician. This data can also be stored in the central controller.

In other words, the possibilities of optical and/or acoustic recognition are used in order to accelerate, simplify and render more secure the maintenance in a warehouse or distribution centre etc.

Accordingly, the method in question is installed or carried out in a warehouse or hall.

Accordingly, the systems in question come from the field of conveying technology, storage technology, picking technology and/or sorting technology.

Conveying technology systems are preferably any type of conveyors, in particular roller conveyors, belt conveyors, overhead conveyors, with and without switches and inward transfer and/or outward transfer facilities.

Storage technology systems preferably include rack serving apparatuses, in particular shuttles, lifts for goods and/or shuttles.

Picking technology includes manual, automated and/or robot-assisted picking stations and their controllers, including the feed and discharge facilities.

Sorting technology includes not only rotary sorters (tilt tray sorters, crossbelt sorters, bombay sorters, pushtray sorters) and linear sorters (slat and shoe sorters), but also sequencing technology such as sorting towers, carousels, multi-stage sorting carousels etc.

The invention thus ensures with a high degree of probability that the service technician has visual contact with the system because he is located at a specific position, which is determined by localising his working device. Remote access is enabled only if e.g. he is located in the immediate vicinity of the conveying technology, storage technology, picking technology and/or sorting technology systems in question.

In accordance with an aspect of the invention provision can additionally be made that, by reason of the determined location of the mobile computer, a selection of reachable systems for maintenance is pre-selected and proposed to the service technician. Therefore, maintenance is speeded up considerably. It is also feasible for a maintenance connection to be made to the closest system automatically or to be cut when the visible range is exited. Furthermore, at this point it is possible to retrieve system-specific documentation and system histories: for instance, the selection of retrievable documents can be significantly simplified.

Error documentation on the part of the service technicians, as well as remote support based on a pre-selected selection of experts/colleagues, can thereby also be simplified in a system-specific manner.

On the one hand, access control can be integrated in the respective system itself or alternatively can be stored in the mobile computer or its programming itself. Furthermore, it is feasible for the determination of the location of the mobile computer to be effected by means of services by a superordinate controller, as may already be present as warehouse control software.

Further details of the invention will become clear from the following description of exemplified embodiments by reference to the drawing.

### BRIEF DESCRIPTION OF THE DRAWINGS

FIG. 1 shows a schematic view of a warehouse with a plurality of conveying technology machines and a maintenance technician.

### DESCRIPTION OF THE PREFERRED EMBODIMENTS

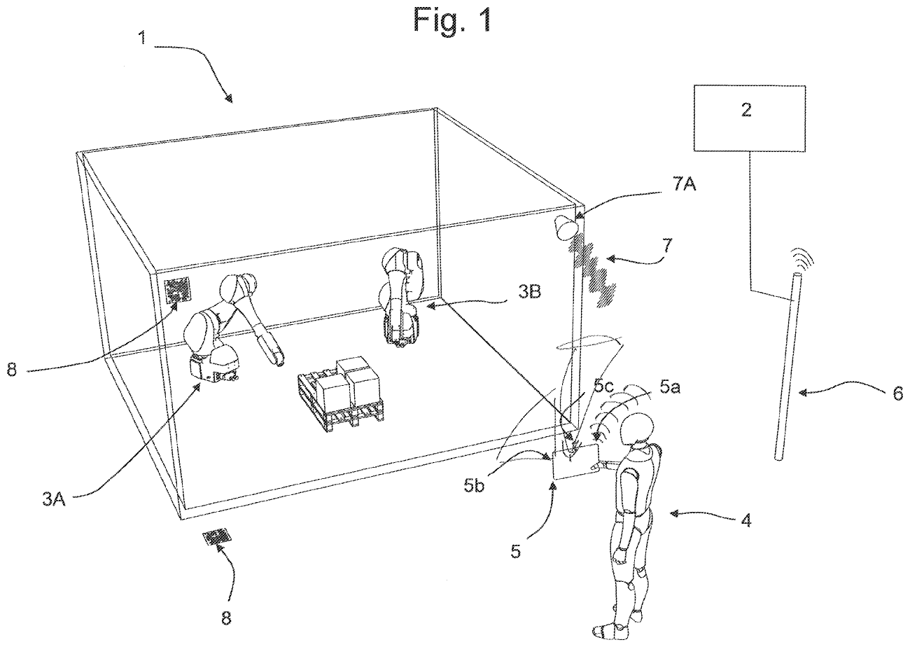

FIG. 1 schematically illustrates a warehouse designated as a whole by 1. The warehouse 1 comprises a superordinate controller 2 and a plurality of conveying technology machines 3A, B which are connected thereto and are designed as picking robots. The central controller has a WLAN radio module 6 which enables communication with a service tablet 5 (mobile computer) which has a corresponding radio module 5a. The system or warehouse 1 has both an optical and an acoustic fingerprint 7, 8.

In the present case, the optical fingerprint 8 is a 2D code which is visibly applied in the immediate vicinity of the conveying technology and which can be recognised or read by the service tablet 5 equipped with a camera 5b. The 2D code contains e.g. the system part and its location. This is exchanged with the central controller 2 which then knows the location of the service tablet 5 and thus also of the technician 4.

In the present case, the acoustic fingerprint 7 is an acoustic signal 7 which the service tablet 5 equipped with a microphone 5c can receive. In the present case, the signal 7 is artificially generated by a sound generator 7A located in the immediate vicinity of the conveying technology. The sound is unique to the conveying technology or conveying technology machines 3A, B and thus allows the central controller to allocate or determine the location of the service tablet 5 and thus also of the technician 4 after appropriate communication.

Thus, as soon as the service technician 4 with the service tablet 5 is located within sight and/or hearing distance of the conveying technology machines 3A, B or the fingerprints 7, 8, access to the conveying technology can be enabled via the central controller 2. In the present case, access is enabled only if both the acoustic and optical evaluation indicate the immediate proximity to the conveying technology machine 3A to undergo maintenance.

For this purpose, the conveying technology must be located in the field of view of the camera 5b or within a radius, in which the audio signal 7 is still recorded with a defined strength or loudly by the microphone 5c. This provides the technician 4 with a more flexible workspace and still ensures visibility to the system. Consequently, he can move within the maintenance area but cannot leave it.

By means of the superordinate controller 2, access is enabled only if the acoustic signals of the microphone 5c and the evaluation thereof indicate the immediate proximity to the conveying technology. Similarly, access can also be enabled only if the evaluation of the images from the camera 5b and the evaluation thereof indicate the immediate proximity to the conveying technology.

The central controller 2 enables access only if the comparison of acoustic signal strength and specified signal strength or live image of the camera and stored images in the database indicates an immediate proximity. Also, access is only enabled or is not blocked if, as well as by constantly monitoring the amplitude of the signal 7 or scanning and recognising the codes 8, the location of the maintenance technician 4 or his tablet 5 does not move outside the maintenance area.

If the technician 4 thus wishes to obtain access to the conveying technology machine 3A or the controller thereof, he must not only authenticate his identity and request access but also be located in an area permitting visual contact with the conveying technology machine 3A. In the present case, this is only the case when he is in the immediate vicinity or environment in the maintenance area of the machine 3A.

This checking and subsequent granting is effected via the superordinate controller 2 by means of the position data of the tablet 5.

Changes and modifications in the specifically described embodiments can be carried out without departing from the principles of the present invention which is intended to be limited only by the scope of the appended claims, as interpreted according to principles of patent law including the doctrine of equivalents.

1. A method for maintaining, commissioning and checking systems in warehouses, wherein a service technician has a view of a respective system and makes wireless contact with a controller of the respective system via a mobile computer in order to take over control thereof, said method comprising:
taking over of control of the respective system by the mobile computer is permitted by a central controller only if the service technician can have visual contact with the corresponding system, for which purpose the determination of the position and/or the orientation of the mobile computer of the service technician with respect to the respective system is effected via optical and/or acoustic recognition of a fingerprint of the system.

2. The method as claimed in claim 1, wherein the acoustic recognition is effected by means of a microphone of the mobile computer which enables the central controller to compare an acoustic fingerprint stored in the central controller with instantaneous acoustic recordings of the noises of the respective system.

3. The method as claimed in claim 2, wherein the acoustic recognition by means of a microphone monitors both the frequency and the volume of the instantaneous noises of the system.

4. The method as claimed in claim 3, wherein the noises are artificially generated noises.

5. The method as claimed in claim 2, wherein the noises are artificially generated noises.

6. The method as claimed in claim 1, wherein the optical recognition is effected by means of a camera of the mobile computer which enables the central controller to compare an optical fingerprint stored in the central controller with instantaneous optical recordings of patterns of the respective system.

7. The method as claimed in claim 6, wherein the optical patterns consists of the system itself, applied markings on the system, markings applied to the ground in front of the system or light patterns on the system or a combination of the aforementioned.

8. The method as claimed in claim 1, wherein the identification of the service technician is also effected by means of optical and/or acoustic recognition.

9. The method as claimed in claim 1, wherein the systems in question come from the field of conveying technology, storage technology, picking technology and/or sorting technology.

10. A method for maintaining, commissioning and checking systems in warehouses, wherein a service technician has a view of a respective system and makes wireless contact with a controller of the respective system via a mobile computer in order to take over control thereof, said method comprising:
determining the position and/or the orientation of the mobile computer of the service technician with respect to the respective system via optical and/or acoustic recognition of a characteristic of the respective system; and
taking over of control of the respective system by the mobile computer is permitted by a central controller only if the service technician can have visual contact with the corresponding system based on said determining the position and/or orientation of the mobile computer.

11. The method as claimed in claim 10, further comprising acoustically recognizing the characteristic of the respective system via a microphone of the mobile computer which enables the central controller to compare an acoustic fingerprint stored in the central controller with instantaneous acoustic recordings of noises of the respective system.

12. The method as claimed in claim 11, wherein said acoustically recognizing via the microphone comprises monitoring both the frequency and the volume of the instantaneous noises of the respective system.

13. The method as claimed in claim 12, wherein the noises are artificially generated noises.

14. The method as claimed in claim 10, further comprising optically recognizing the characteristic of the respective system via a camera of the mobile computer which enables the central controller to compare an optical fingerprint stored in the central controller with instantaneous optical recordings of patterns of the respective system.

15. The method as claimed in claim 14, wherein the optical patterns consists of the system itself, applied markings on the system, markings applied to the ground in front of the system or light patterns on the system or a combination of the aforementioned.

16. The method as claimed in claim 10, further comprising identifying the service technician by means of optical and/or acoustic recognition.

17. The method as claimed in claim 10, wherein the systems in question come from the field of conveying technology, storage technology, picking technology and/or sorting technology.
